(19) United States
(12) Patent Application Publication
(10) Pub. No.: US 2026/0097534 A1
(43) Pub. Date: Apr. 9, 2026

(54) SYSTEM AND METHOD FOR DYNAMIC ACCUMULATOR AND SINGULATING ROTOR

(71) Applicant: DW Energy LLC, Wilsonville, OR (US)

(72) Inventors: Brady L. Byers, Newberg, OR (US); Dan Alexander Sturges, Lake Oswego, OR (US)

(21) Appl. No.: 19/351,871

(22) Filed: Oct. 7, 2025

Related U.S. Application Data
(60) Provisional application No. 63/704,072, filed on Oct. 7, 2024.

(51) Int. Cl. B26D 1/04; B26D 7/00; B26D 7/01

(52) U.S. Cl. CPC B26D 1/045; B26D 7/018; B26D 2007/0012

(57) ABSTRACT

The present disclosure generally relates to a dynamic accumulation device that ensures that continuous and precise feeding of film material is provided at a constant rate to a singulation device, which operates in an indexing or stepwise motion. This device receives the film material from a film dispensing device at a steady rate and adjusts its output to match the varying speed requirements of the singulation process. By accumulating and releasing the film material dynamically, the device compensates for the intermittent motion of the singulation device, ensuring smooth operation without tearing or misaligning the material. This functionality is crucial in high-precision battery stacking systems, where maintaining continuous film supply with variable output is essential to meet production efficiency and quality control standards.

### CROSS-REFERENCE TO OTHER APPLICATION

This Application claims the benefit of and priority to U.S. Provisional Application No. 63/704,072 filed Oct. 7, 2024, the contents of which are hereby incorporated by reference.

### COPYRIGHT NOTIFICATION

Portions of this patent application contain materials that are subject to copyright protection. The copyright owner has no objection to the facsimile reproduction by anyone of the patent document or the patent disclosure, as it appears in the U.S. Patent and Trademark Office, but otherwise reserves all copyright rights whatsoever.

### FIELD OF THE DISCLOSURE

The present invention generally relates to apparatus, systems, and methods for the continuous in-feeding of singulated battery material and, in particular, to one or more methods and apparatuses for continuously feeding battery material at a constant rate to a singulation device that singulates electrodes and separators in an indexing or stepwise motion and depositing the singulated battery material onto the downstream picking device of a battery stacking system.

### BACKGROUND OF THE DISCLOSURE

Battery stacking, a critical process in modern battery manufacturing, involves arranging multiple battery cells to form a complete module or pack. The cells, which can be cylindrical, prismatic, or pouch-shaped, are stacked in layers with alternating anode and cathode layers, separated by insulating separators. This stacking process aims to increase the energy density and power capacity of battery systems, making it a key technology in applications such as electric vehicles (EVs), grid storage, and portable electronics. The stacking process must ensure consistent alignment and minimal spacing to avoid performance losses or safety risks due to short circuits or thermal events.

In the stacking process, automated systems are often used to handle the precise placement of electrodes and separators. The critical challenge in battery stacking manufacturing is maintaining high throughput while ensuring the accurate alignment of each layer. This is particularly important in high-performance batteries, such as those using lithium-ion chemistry, where even slight misalignments can affect the electrochemical performance and lifecycle of the battery. Innovations in automation and robotics, such as laser alignment and machine vision systems, are increasingly employed to improve the precision and speed of the stacking process. This not only enhances production efficiency but also significantly reduces the cost of high-volume battery manufacturing, painting an optimistic picture of the future of the industry.

Z-stacking batteries, while offering higher energy density by vertically stacking cells in layers, comes with several limitations and challenges. One of the primary issues is the difficulty in ensuring precise alignment across multiple layers, as any misalignment can result in uneven pressure distribution, leading to mechanical stress on the electrodes and separators. In extreme cases, this can cause performance degradation, internal short circuits, or even thermal runaway.

Current separator material singulation devices face several challenges that impact their efficiency and reliability. One key issue is the inconsistency in separating materials, particularly when dealing with thin, fragile, or flexible substances prone to tearing or deformation. Additionally, many devices struggle with precision, leading to misalignment or incomplete separation, affecting downstream processes. Mechanical wear and tear on components can also result in frequent maintenance or replacement, increasing downtime and operational costs. Furthermore, current systems may not adequately handle variations in material properties, such as thickness or texture, reducing their overall versatility and performance in diverse industrial applications.

Therefore, what is missing in battery stacking systems today is a dynamic accumulation device that allows for the continuous feeding of battery material at a constant rate to a singulation device that singulates electrodes and separators in an indexing or stepwise motion and deposits the singulated battery material onto a downstream process without defects or misalignments, thus ensuring greater precision and reduced manufacturing defects at scale than traditional Z-stacking systems.

### BRIEF SUMMARY OF THE DISCLOSURE

This summary is provided to introduce a selection of concepts in a simplified form that are further described in the detailed description of the disclosure. This summary is not intended to identify key or essential inventive concepts of the claimed subject matter, nor is it intended to determine the scope of the claimed subject matter.

In an embodiment of the present disclosure, the dynamic accumulation and singulation device includes a device for singulating separator material comprising a rotating body with at least two substantially flat faces. These flat faces are configured to receive a film material and rotate in an indexing or stepwise motion. The device also includes a cutting device with a cutting edge, designed to cut the film material while it adheres to one of the flat faces of the rotating body during its stepwise motion.

In another embodiment of the present disclosure, the dynamic accumulation and singulation device includes an index motion that involves a complete stop of the rotating body and cutting the film during the stop.

In yet another embodiment of the present disclosure, the dynamic accumulation and singulation device includes flat faces adapted to adhere to the film material using suction.

In an embodiment of the present disclosure, the dynamic accumulation and singulation device includes flat faces adapted to apply different amounts of suction to each face.

In another embodiment of the present disclosure, the dynamic accumulation and singulation device includes flat faces that are individually compliant, allowing them to be displaced toward the center of the rotating body. As further discussed below, compliance is generally achieved by a spring means associated with each flat face.

In yet another embodiment of the present disclosure, the dynamic accumulation and singulation device includes flat faces that are adapted to transfer the film material to a picking device after it has been cut.

In an embodiment of the present disclosure, the dynamic accumulation and singulation device includes a cutting edge or blade.

In another embodiment of the present disclosure, the dynamic accumulation and singulation device includes flat faces that are adapted to receive the cutting edge.

In yet another embodiment of the present disclosure, the dynamic accumulation and singulation device includes four flat faces. In other embodiments, the dynamic accumulation and singulation device may include more than four (e.g., six) flat faces.

In an embodiment of the present disclosure, the dynamic accumulation and singulation device includes a rotating body with at least two flat faces configured to receive the film material and rotate in an indexing or stepwise motion. The system includes a cutting device with a cutting edge designed to cut the film material while it adheres to one of the flat faces of the rotating body during the stepwise motion. Additionally, the system features a dynamic accumulation device for transferring the film material to the singulation device. This dynamic accumulation device is configured to receive the film material at a constant rate and output it to the singulation device at a varying rate.

The present disclosure relates to a battery manufacturing device capable of creating a battery stack using a continuous singulated lamination process by successively controlling a plurality of parameters, including the above-mentioned novel features, such as (but not limited to), in various embodiments, the alignment of anode and cathode sheets, the input and output speed of in-feed conveyors, the rate at which the battery material is dispensed, the indexing rate, the speed and direction of the dynamic accumulation drum, and the pressure applied to battery material. The battery manufacturing device includes various sensors, including but not limited to pressure sensors, alignment sensors, tension sensors, temperature sensors, vibrational sensors, and cameras to ensure precise singulation and quality control.

### BRIEF DESCRIPTION OF THE DRAWINGS

The foregoing summary, as well as the following detailed description of the disclosure, is better understood when read in conjunction with the appended drawings. For the purpose of illustrating the disclosure, exemplary constructions of the inventions of the disclosure are shown in the drawings. However, the disclosure and the inventions herein are not limited to the specific methods and instrumentalities disclosed herein.

FIG. 1 illustrates a singulation device in accordance with an aspect of the present disclosure.

FIG. 2 illustrates a second view of the singulation device of FIG. 1 in accordance with an aspect of the present disclosure.

FIGS. 3A and 3B illustrate a rotating body of the singulation device in accordance with an aspect of the present disclosure.

FIGS. 4A and 4B illustrate a vacuum regulation system in accordance with an aspect of the present disclosure.

FIG. 5 illustrates a system including the singulation device in accordance with an aspect of the present disclosure.

FIG. 6 shows the steps of a method of singulation in accordance with an aspect of the present disclosure.

FIGS. 7A-7F illustrates a dynamic accumulation device for the singulation device in accordance with an aspect of the present disclosure

FIG. 8 shows the steps of a method of learning or calibrating the dynamic accumulation device in accordance with an aspect of the present disclosure.

### DETAILED DESCRIPTION OF THE DISCLOSURE

The following disclosure as a whole may be best understood by reference to the provided detailed description when read in conjunction with the accompanying drawings, drawing description, abstract, background, field of the disclosure, and associated headings.

Identical reference numerals when found on different figures identify the same elements or a functionally equivalent element. The elements listed in the abstract are not referenced but nevertheless refer by association to the elements of the detailed description and associated disclosure.

In the following detailed description, reference is made to the accompanying drawings that show, by way of illustration, an embodiment of the disclosure centered around an improved battery stacking system. This embodiment is described with detail sufficient to enable a person of ordinary skill in the art to practice the disclosure. It is understood that each subfeature or element described in this embodiment of the disclosure, although unique, is not necessarily exclusive and can be combined differently and in a plurality of other possible embodiments because they show novel features.

It is understood that the location and arrangement of individual elements, such as geometrical parameters within each disclosed embodiment, may be modified without departing from the spirit and scope of the disclosure. The disclosed apparatus can be modified according to known design parameters to implement this disclosure within these specific types of operation. Other variations will also be recognized by one of ordinary skill in the art. Therefore, the following detailed description is not to be taken in a limiting sense.

### System for Transferring Electrodes to a Battery Stack

The present disclosure relates to a system for continuous feeding of battery material at a constant rate to a singulation device that singulates electrodes and separators in an indexing or stepwise motion and deposits the singulated battery material onto a downstream process without defects or misalignments, thus ensuring greater precision and reduced manufacturing defects at scale than traditional Z-stacking systems.

Briefly described, the present solution relates to a device for cutting film material into pieces, which is herein called a singulation device. The device comprises a body with at least two faces adapted to rotate around an axis, wherein each face is adapted to receive the film material and adhere the film material to the face.

As disclosed herein, the singulation device further comprises a cutting device adapted to cut the film material while it adheres to one of the faces. The body is adapted to rotate in a motion comprising acceleration followed by deceleration, which may include a complete stop, and the cutting device is adapted to cut the film material after the deceleration. During rotation, the singulation device is adapted to withdraw certain amount of film material. For instance, one withdrawing and/or rotating operation usually can withdraw an amount of film material corresponding to the size of one of the faces of the device. After the film material has been cut, it may be handed over to another device for transporting it to the battery stack. The acceleration and deceleration of the index motion is generally a rapid acceleration and deceleration, in order to achieve high speeds of the singulation device and the system in which it operates.

The present disclosure builds upon a realization that cutting singulated sheets of separator material at very high speeds can be highly beneficial when manufacturing battery stacks of prismatic, pouch, and solid-state batteries. Due to how difficult the separator is to handle, other current solutions involve laminating or otherwise treating it in order to make it easier to handle. However, cutting the film material into pieces at the same speed as the battery is being stacked can improve the battery manufacturing process and obviate the need for lamination or similar processes. Further, in order to enable very high manufacturing speeds, e.g., 0.2 seconds per battery layer, the separator needs to be singulated and cut at this speed as well, i.e., a maximum of 0.2 seconds per singulated sheet. Thus, the present solution aims to provide a device that can not only singulate and cut a separator material but can do so at very high speeds.

For the purpose of this disclosure, a film material is a thin and at least somewhat flexible material, wherein the material may be, e.g., nonwoven fibers, polymer films, and naturally occurring substances such as rubber and asbestos. The film material may be in the form of a sheet, a web, or a mat and may comprise directionally or randomly oriented fibers. The film material may include single or multiple layers of material. In an embodiment, the film material is a web of separator material.

Anodes and cathodes are referred to collectively as electrodes. A collection of alternating anodes and cathodes with a separator between adjacent anodes and cathodes is called a battery stack. Anodes, cathodes, and separators are referred to collectively as battery material.

For the purpose of this disclosure, an index motion is a motion intended to position something in a specific position, usually with high precision. The most common index motion referenced in this disclosure is a repeating motion comprising acceleration, which may be a rapid acceleration, followed by deceleration, which may be a rapid deceleration. The index motion may further include a complete stop after the deceleration. One iteration of the index motion comprises a 90-degree rotation. In some embodiments, the index motion is a motion that comes to a complete stop at regular intervals. For example, a motion that occurs at stepwise intervals.

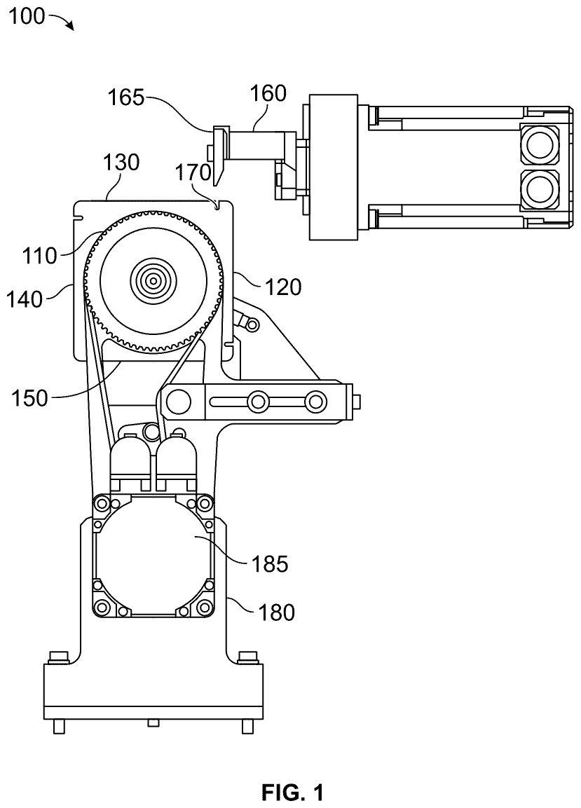

FIG. 1 illustrates one embodiment of a singulation device 100. The singulation device 100 comprises a rotating body 110, comprising four substantially flat faces 120, 130, 140, and 150. In some embodiments, the rotating body 110 may include more or fewer faces. The minimum number of faces is at least two faces configured with a vacuum gripping surface. In some embodiments, the corners of the faces are rounded in order to avoid scrubbing that causes the film material to bunch, break, or deform. In some embodiments, the singulation device 100 includes six faces. In some embodiments, all the faces have the same shape and size, and in some embodiments, the faces may differ in size and/or shape.

As illustrated in FIG. 1, although the faces 120, 130, 140, and 150 may be identical and change positions as the rotating body 110 of the singulation device 100 rotates, they will, for the purpose of FIG. 1, be referenced as first face 120, second face 130, third face 140, and fourth face 150. The reference numerals 120, 130, 140, and 150 will also be referenced interchangeably as first position 120, second position 130, third position 140, and fourth position 150.

At least one of the positions of the faces of the singulation device 100 is a cutting position in which the film material is cut. At least one of the positions is a receiving position where the rotating body 110 receives the film material from a film-transferring device or a dynamic accumulation device 410.

As further shown, at least one position is an output position adapted to hand off the film material to a downstream picking device after it has been cut. In some embodiments, these positions may overlap, especially in embodiments wherein the singulation device comprises a few faces, such as two. For example, the first position may be both a receiving position and a cutting position, and/or the second position may be both a cutting position and an output position. The faces 120, 130, 140, and 150 are configured to receive a film material fed from a transferring device or a dynamic accumulation device 410. The faces are further configured to include a series of holes or perforations that generate a vacuum and air jet force. The faces use the vacuum force to secure the film material to the faces.

In other embodiments, each face 120, 130, 140, and 150 is adapted to adhere to the film material by suction. The suction may be provided by a vacuum source connected to the singulation device 100. In some embodiments, the faces may be adapted to adhere to the film material by other means, such as electrostatically, mechanically, or sticky or tacky surfaces.

In some embodiments, the singulation device 100 is adapted so that each face may be controlled individually with respect to adhering the film to the respective face. In some embodiments where the adhering is achieved by suction, the amount of suction provided can be adjusted for each face individually. In some embodiments, the singulation device 100 is adapted such that the adhering of film material is either on or off for all faces simultaneously. In embodiments wherein the adhering is accomplished via suction, it may entail that all faces are provided with the same amount of suction. The rotating body 110 rotates around a central axis. The singulation device 100 is configured such that the rotating body 110 rotates symmetrically around the axis, but in some embodiments, the rotating body 110 may also rotate asymmetrically.

As further illustrated, in various other embodiments, the rotating body 110 rotates using an indexing motion, such that it first accelerates relatively quickly from a standstill and then decelerates relatively quickly in order to position the film material for cutting and/or for being picked up by a picking device. A complete stop typically follows the deceleration, but in some embodiments, it may comprise a slow rotation speed without ever stopping completely. In the embodiment of FIG. 1, one rotation operation or one index motion would rotate the body 90 degrees, such that a position of the first face 120 changes to the second position 130, the second face 130 changes to the third position 140, and so on.

The singulation device 100 further comprises a cutting device 160. The cutting device 160 may, in some embodiments, be incorporated into the same structure as the rotating body 110 of the singulation device 100. In some embodiments, such as the one shown in FIG. 1, the cutting device is external to the rotating body 110. The cutting device 160 comprises a cutting edge 165 adapted to cut the film material while it is being adhered to the face of the singulation device 100. In some embodiments, the cutting edge 165 may be a physical cutting edge such as a knife or a sharp edge. In some embodiments, the cutting edge 165 may be a laser or another type of energy source. In some embodiments, the cutting edge 165 may comprise a hot knife or a hot wire.

In some embodiments, each face 120, 130, 140, and 150 may comprise an internal cutting device, which cuts the film material from the inside with respect to the rotating body 110. By having an internal cutting device on each face, it is easier to cut the film material during the motion of the singulation device 100, which may be beneficial in some implementations.

In alternate embodiments, each face 120, 130, 140, and 150 of the singulation device 100 includes a feature 170 adapted to receive the cutting edge 165 of the cutting device 160. In the embodiment shown in FIG. 1, feature 170 is an indentation adapted to receive the physical cutting-edge 165.

As illustrated in FIG. 1, there are four different positions, 120, 130, 140, and 150, for the film material, one for each face. The process of rotating the rotating body 110 of the singulation device 100 will be further discussed below. The first position, 120, is the first face the film material transfers when the singulation device 100 rotates. By way of example and not limitation, when the first film material is being pulled onto the first face 120, the first film material adheres to the first face 120 on the singulation device 100 due to a suction force. The rotating body 110 is then rotated such that the film material positioned at the first face 120 becomes positioned on the second face 130, and new film material is withdrawn from the dynamic accumulation device onto the first face 120. When the film material is positioned on the second face 130, it is cut by the cutting edge 165 of the cutting device 160.

The rotating body 110 then rotates again, transferring the film material from the second face 130 to the third face 140. Since the film material was cut at the second face 130, it is no longer part of a web or continuous sheet of material and can be transferred. In some embodiments, the film material is transferred to another device adapted to pick the film material from the third face 140. Then, the rotating body 110 rotates again, and if the film material was transferred at the third face 140, no film material is present at the fourth face 150. However, in some embodiments, the singulation device 100 may be adapted to transfer the film material from the fourth position.

In other embodiments, transferring the film material from either of the third or fourth faces requires releasing the adhering of the film material to the face. If it is adhered to by suction, this would comprise releasing or lessening the suction.

In some embodiments where the film material is transferred at the third 140 or fourth position 150, the suction may be released, and the film material would fall to the transferring device.

In other embodiments, the singulation device 100 may further comprise a mechanism for rejecting faulty or damaged pieces of film material, after it has been cut. Rejection is handled using air to push the film material away from the face after it has been cut. Typically, such a rejection is performed at the second 130 or third 140 positions or between the second and third positions. The air used to push the film material away may also be generated using the same source that applies suction to the faces of the body 110; for example, the suction may be reversed into positive pressure to blow off the sheet. As illustrated, the singulation device 100 further comprises a base 180, on which the rotating body 110 is positioned. In some embodiments comprising a base 180, the singulation device 100 may be adapted such that the rotating body 110 can pivot and/or deflect relative to the base 180. By allowing this deflection motion, transfer of the film material to a picking device after it has been cut may be facilitated in case the picking device physically contacts the singulation device 100 when picking up the film material.

In some embodiments, the base 180 may comprise a motor 185, adapted to rotate the singulation device 100 and optionally perform other operations as well. In some embodiments, the motor 185 may be positioned at other places, such as inside the rotating body 110. As illustrated, each of the faces 120, 130, 140, and 150 of the rotating body 110 can be deflected individually in order to allow for a picking device to pick the film material without colliding or risking interfering with the singulation device 100. In some embodiments, such deflection may be accomplished by spring means associated with each face. In some embodiments, deflection may be accomplished by foam or other resilient materials. The foam may either be provided on the faces, such that it is in contact with the separator material, or it may be provided behind the surface portion of the faces.

Battery quality is a measurement of electrode placement accuracy. Quality inspection systems for battery stacking ensure that the electrodes (anodes and cathodes) and separators are properly aligned and defect-free before and during the stacking process. These systems often employ advanced technologies such as optical, X-ray, or laser-based sensors to detect misalignments, foreign particles, or material defects that could compromise battery performance and safety. Real-time monitoring is essential, as even minor deviations can lead to short circuits, reduced capacity, or thermal events. Inspection systems may also include impedance spectroscopy and other electrical testing methods to verify the integrity of the stacked layers. Integrated with automation, these quality control systems enable continuous monitoring and corrective actions, minimizing defects and ensuring high reliability in the final battery stacks used in electric vehicles, energy storage, and other applications. In an embodiment, the quality inspection device includes an optical camera, which is not shown, to determine if the film material is faulty or misaligned. The control box 190 may be configured to receive real-time images of the edges of the film material to detect misalignments and defects. If a misalignment or defect is detected, the control box 190 sends a signal to either the rejection device, the singulation device 100, or the dynamic accumulation device to initiate a rejection process of the individual sheet of film material.

In some embodiments, the quality inspection system is configured to generate a digital twin of the entire battery stack throughout the entire stacking process. Using a digital twin in quality inspection for battery stacking systems offers numerous benefits by creating a real-time, virtual replica of the physical manufacturing process. This advanced method allows manufacturers to simulate, monitor, and optimize production without interrupting the workflow. A digital twin can track and analyze data from various sensors in the battery stacking system, providing insights into potential defects, misalignments, or inconsistencies in the stacking of electrodes and separators. Manufacturers can make immediate adjustments by predicting issues before they occur, minimizing downtime, and reducing waste. Additionally, the digital twin enhances predictive maintenance by monitoring the health and performance of machinery, preventing breakdowns. Overall, this method improves the precision, efficiency, and reliability of the battery manufacturing process, ensuring higher quality control standards and reducing production costs.

For example, the singulation device 100 can compare the digital twin for various stacks, lots, or even individual battery material sheets as they move throughout the singulation device 100. By comparing the digital twin at multiple checkpoints throughout the singulation process, control box 190 can determine if there is an issue with a specific subsystem. Additionally, by comparing the digital twin between various lots of batteries, the control box 190 can automate the detection, classification, and reporting of potential recalls due to misalignments or defects.

A control box 190 (not shown) is coupled to the singulation device 100. The control box 190 includes various control components or processors, such as PLCs, sensors, displays, etc., that adjust multiple parameters, receive sensor data, and control the stacking device 100. The control box 190 is configured to control various functions of the singulation device 100, including but not limited to rejection, quality inspection, battery material alignment, pick and place operations, film material cutting, indexing, and vibrational analysis. A person of skill in the art would understand that the discrete tasks disclosed throughout may be performed within a single control box 190 or multiple control box 190s, depending on the needs of the upstream and downstream processes.

Vibrational analysis plays a critical role in monitoring and optimizing singulation machines by detecting mechanical irregularities or misalignments in real-time. This technique measures the vibration patterns of moving components, such as conveyors, transfer devices, and gripping faces, during the singulation process. Any deviation from normal vibration signatures can indicate issues like wear, imbalance, or misalignment in the machinery, which could negatively affect the precision of singulation. By identifying these anomalies early, operators can prevent defects in singulated film material, which may lead to performance degradation or safety risks. Additionally, vibrational analysis can help optimize machine performance, ensuring smoother operation, longer machine life, and reduced downtime for maintenance, contributing to overall efficiency and cost-effectiveness in battery manufacturing. In an embodiment, the control box 190 performs vibrational analysis on the singulation system 100 to ensure proper alignment and operation during singulation.

The control box 190 may also be configured to activate or deactivate various upstream or downstream apparatuses, including the dynamic accumulator device 410, the film dispensing device 420, and the alignment device 430. The control box 190 is configured to receive feedback from the film dispensing device 420, and the alignment device 430 in order to determine the proper spool speed, accumulator speed, and rotor speed.

In an embodiment, the control box 190 includes a display (not shown) configured to display a human-machine interface (“HMI”) containing information on the stacking system 100. A user may interact with the HMI and display to set various parameters of the stacking system 100. The rotating body 110 can be configured to gradually, rather than all at once, transfer the singulated film material. By releasing the singulated film material one part at a time, a smoother and more accurate transfer may be achieved, decreasing the risk of damaging the film material.

To achieve a gradual transfer, the surface of the faces of the body may contain multiple zones in which a vacuum or jet of air may be applied individually. The angular position of each vacuum zone is tracked to determine if the various vacuum zones have reached a predetermined position. The multiple vacuum zones are turned off when the predetermined position is reached.

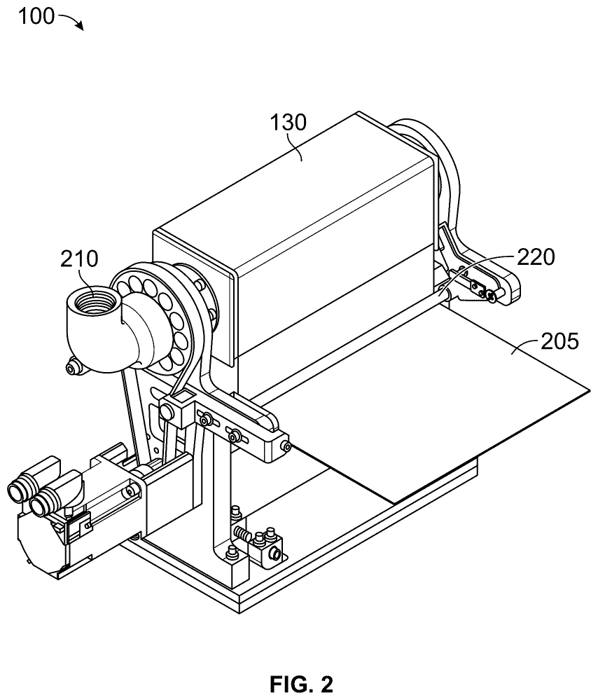

As illustrated in FIG. 2, a different view of the singulation device 100 of FIG. 1 is shown. FIG. 2 also shows the film material 205 being fed onto the singulation device 100. The film material 205 may be fed from any source able to output the film material to the singulation device 100 without breaking or damaging the film. Due to the index motions used in embodiments of the singulation device comprising rapid acceleration, it may be necessary to withdraw the film material from a source with low or no inertia and/or friction. In some embodiments, the film material is withdrawn from a buffering device adapted to output the film material specifically to the singulation device.

As described previously, the singulation device 100 may use suction in order to adhere the film material to the faces 120, 130, 140, and 150 of the body 110. FIG. 2 shows a tube 210 which may be connected to a vacuum source, which can be used to regulate the suction of the faces.

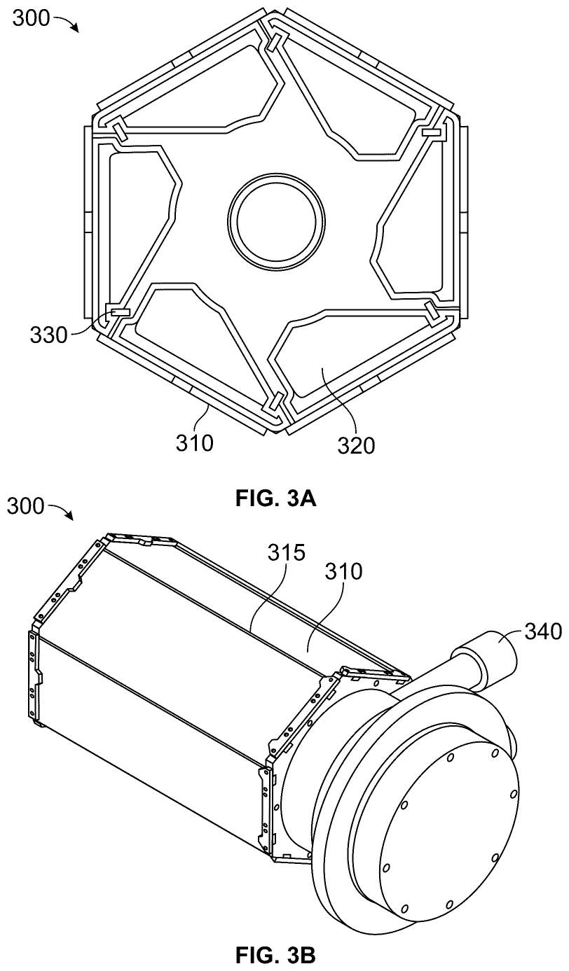

In some embodiments, the singulation device 100 may further comprise an alignment bar 220, which ensures that the film material 205 is fed onto the body 110 of the singulation device 100 optimally. As illustrated in FIG. 3A, an alternative embodiment of a rotating body 300 of the singulation device 100 is shown. In this embodiment, the rotating body 300 comprises six faces 310. As with the embodiment with four faces, the adhering of film material to a single face may be accomplished individually or collectively for all faces, depending on the implementation.

In some embodiments, each face of the rotating body 300 can deflect inwardly using one or multiple springs.

In some other embodiments, each face of the rotating body 300 comprises a feature 310 adapted to receive a laser beam or similar, in case the cutting edge 165 comprises a laser. The feature 310 may deflect the laser beam so that it doesn't risk damaging the body 300. As further shown in FIG. 1 and FIG. 3, the surface material of the face of the body of the singulation device, i.e., the surface on which the film material is positioned and adhered, is made of any type of plastic material, aluminum, or titanium. In some embodiments, the material may be glass-impregnated nylon.

FIG. 3B shows another view of a six-sided singulation device 300, showing the faces 310 as well as a recess 315 in between each face through which the cutting edge of the cutting device may be employed in order to cut the film material. FIG. 3B further shows a vacuum supply 340 for providing suction to the faces 310.

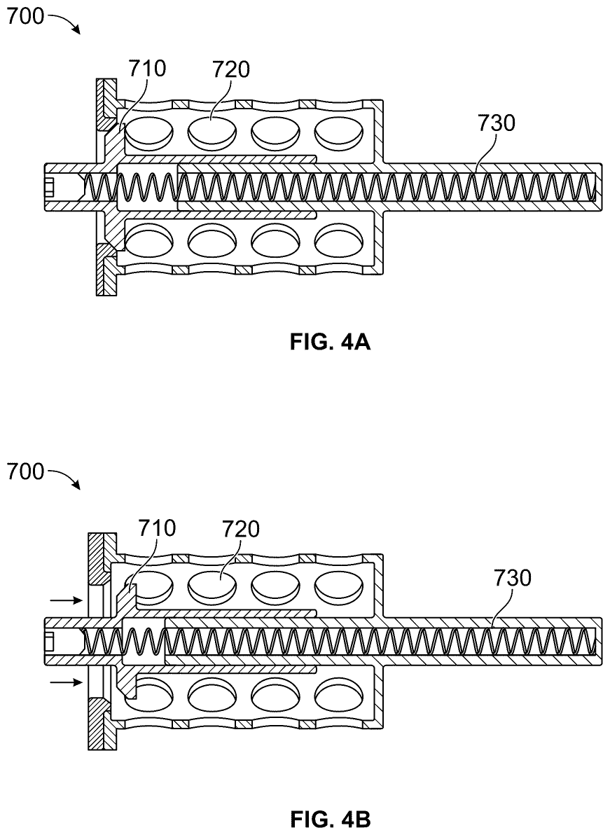

As illustrated at FIGS. 4A and 4B, a mechanism for regulating the suction of the faces of the body used to adhere to the film material, will now be described. FIG. 4A shows a closed position where no air is let in, and FIG. 4B shows an open position in which air is let in. The mechanism may be used regardless of the number of faces of the body, and it may be used either for all faces simultaneously or for each face individually. In an embodiment, the mechanism is positioned inside the singulation device body 110. As will be understood, the body 110 may comprise one or a plurality of vacuum regulation mechanisms 700.

The mechanism 700 comprises a valve 710, which may be opened and closed in order to adjust the amount of air or other gas that is let in, which in turn regulates the amount of vacuum. The valve 710 may be continuously positionable between an opened and a closed position, such that the amount of air that is let in can be continuously adjusted and not only have two discrete positions. As illustrated, the mechanism comprises a number of holes 720, adapted to let air or gas through in order to apply the suction to the faces of the singulation device. The holes 720 are generally positioned on the surface of the faces of the singulation device. The mechanism may further comprise a spring 730, which may automatically or semi-automatically adjust the amount of air that is let in, thereby regulating the vacuum. When the amount of vacuum inside the mechanism increases, the spring 730 is contracted, which decreases the extension of the spring and opens valve 710, which in turn lets more air into the mechanism. When more air is let in, the amount of vacuum decreases, which decreases the pressure on the spring and lets the spring extend, which closes valve 710 and increases the amount of vacuum in the mechanism.

By having an automatically adjustable mechanism for regulating the vacuum, a more robust and efficient application of suction on the faces of the singulation device may be achieved.

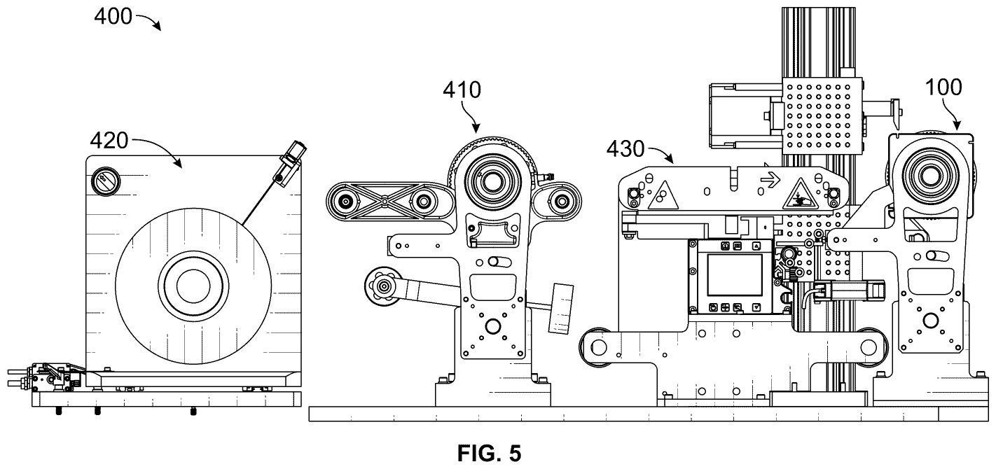

As illustrated in FIG. 5, an exemplary system 400 in which a singulation device 100 according to the present disclosure may be used is shown.

The singulation device 100 requires some type of device to feed the film material to it. Due to the index motion used by the singulation device to withdraw the film material, comprising a rapid acceleration followed by a rapid deceleration and typically a complete stop, the film material must be fed in a virtually frictionless way, which in turn entails that the withdrawal of film material is virtually free from inertia. If this is not the case, the withdrawal of the film material with such an index motion would damage the film, or it would not be possible at all.

In some embodiments, the singulation device 100 may be fed by a dynamic accumulation device 410, which in turn is receiving film from a film dispensing device 420. The film dispensing device 420 may be a dereeler assembly comprising a roll of film material wound around an air chuck. Withdrawing the film material with an index motion as described herein would not be possible from such a film dispensing device 420. Thus, an intermediary device in the form of a dynamic accumulation device 410 is required.

The dynamic accumulation device 410 is adapted to receive film material from the film dispensing device 420 at a constant speed and output the film material at a variable speed to the singulation device 100, wherein the variable speed may be the index motion with which the singulation device 100 withdraws the film material from the dynamic accumulation device 410.

In some embodiments, the dynamic accumulation device 410 may comprise a dancer's arm and a treadle, wherein the film material is adapted to travel with the constant speed through the rollers of the dancer's arm and treadle to travel with the variable speed through the rotating body 110.

In some embodiments, the system may further include an alignment device 430 that adjusts the film material in real-time using the quality inspection device to make small adjustments in the cross-feed direction to ensure that the film material is fed onto the rotating body 110 with the proper alignment.

In some embodiments, the system may further comprise a picking device (not shown). The picking device is adapted to pick sheet of film material from the singulation device 100 after it has been cut. In some embodiments, the picking device comprises an arced surface that comes into contact with the face of the singulation device as it picks up the cut film material.

In some embodiments, the picking device is adapted to pick up the film material using suction. It may thus comprise suction means for adhering the film material to the picking device. In some embodiments, the picking device is adapted to use its suction to adhere an electrode to it while also adhering to the cut film material. In some embodiments, the picking device is adapted to transport the film material, and optionally also the electrode, from the singulation device to a battery stack, wherein the film material is the separator material used in battery manufacturing.

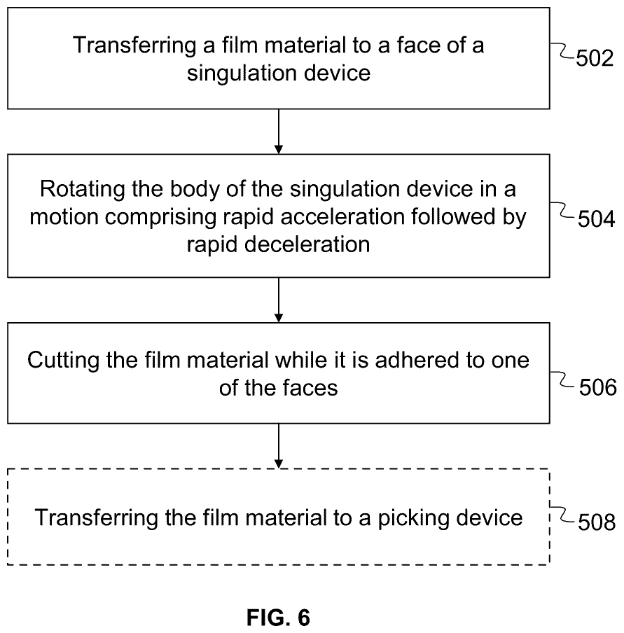

As illustrated in FIG. 6, a method 500 for cutting a film material into pieces according to an embodiment will now be described.

The method comprises transferring 502 a film material to the face of a singulation device as described to embodiments herein, comprising a body with at least two substantially flat faces for receiving the film material, wherein each face is adapted to adhere the film material to the face, wherein the body is adapted to rotate around an axis. The method further comprises rotating 504, the body of the singulation device in an index motion comprising rapid acceleration followed by rapid deceleration. By rotating 504, the film material is transferred from a first position to a second position on the singulation device. By rotating again, the film material may be transferred again from a second to a third position, from a third to a fourth, and so on, depending on how many faces the singulation device comprises. At least one of the positions is a cutting position in which the singulation device can cut the film material.

The method further comprises cutting 506 of the film material while it adheres to the face of the singulation device. The method may, in some embodiments, further comprise transferring 508 of the film material to a picking device. In some embodiments, the transferring 508 comprises stopping the adhering of the film material to the face when the picking device picks it.

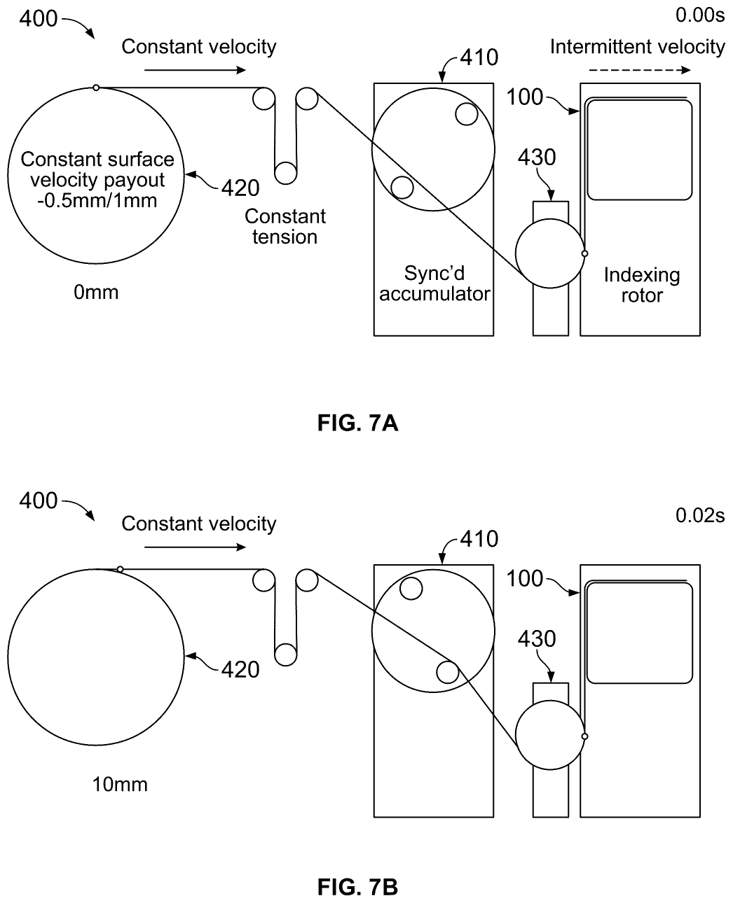

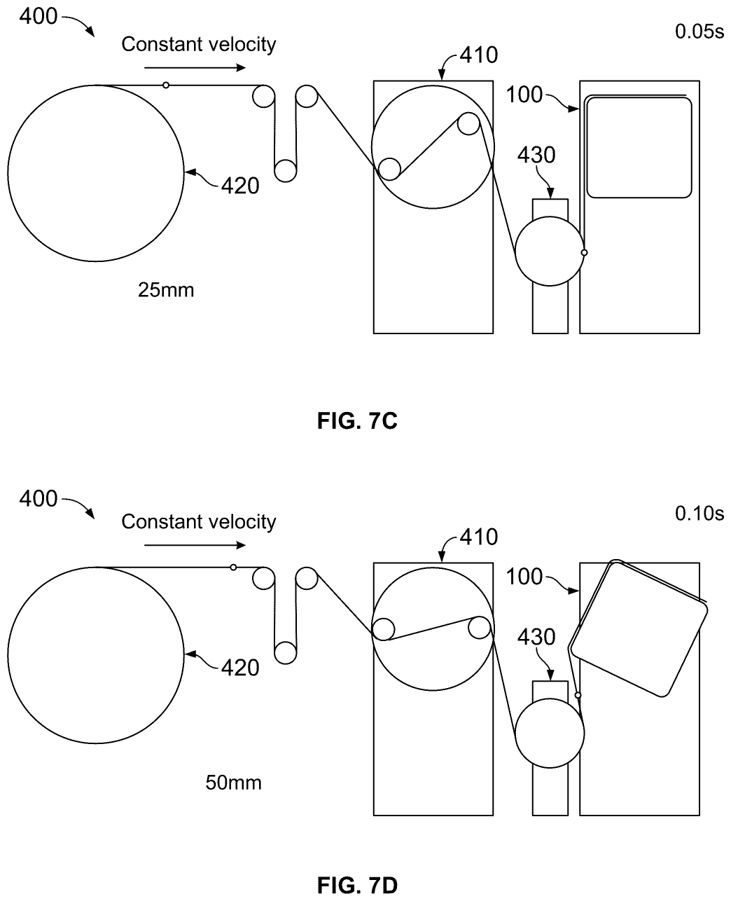

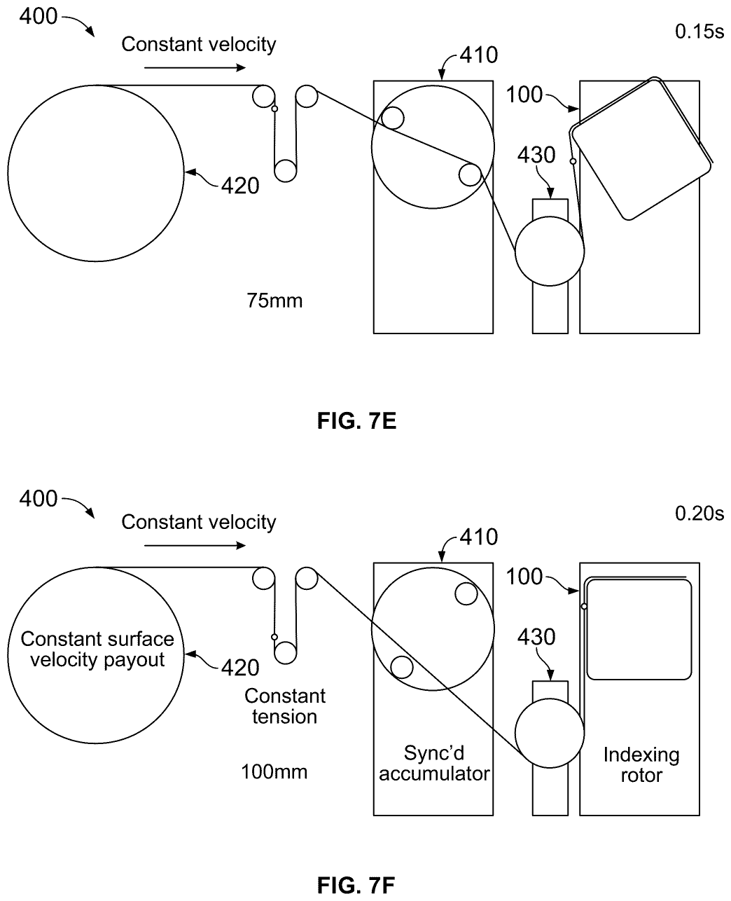

FIGS. 7A-7F shows the dynamic accumulation device 400 through various stages of tension accumulation and indexing. In FIG. 7A, the film dispensing device 420 outputs a constant velocity. The dynamic accumulation device 410 uses a treadle that pivots clockwise and counterclockwise to help control the accumulation needed to transition from a constant velocity to the intermittent velocity of the simulation device 100. A treadle tension device regulates and maintains consistent tension in a web of film as it moves through various stages of processing or production. This device typically employs rollers or a pivoting arm that exerts controlled pressure on the film web, ensuring that the tension remains even across its width. By maintaining uniform tension, the treadle tension device prevents issues such as wrinkling, stretching, or tearing of the film, which can otherwise compromise the quality of the material. The device also enables precise web speed control, improving synchronization with other machinery and optimizing production efficiency. Additionally, the adjustable nature of the treadle mechanism allows it to accommodate different film materials and thicknesses, making it a versatile solution in film handling systems.

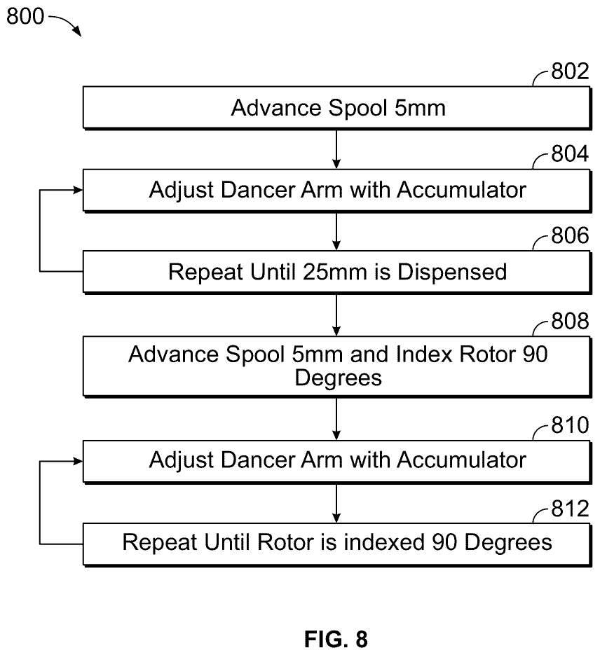

In FIGS. 7B and 7C, the dynamic accumulation device 410 advances counterclockwise to build up an excess of film material on the treadle. Then, as shown in FIG. 7D, as the singulation device 100 indexes, the treadle of the dynamic accumulation device 410 advances clockwise to release the built-up excess film material. This process continues in FIGS. 7E and 7F until the next sheet of film material is singulated. In FIG. 8, method 800 for calibrating or learning the indexing motion of the singulation device 100 is shown. At step 802, the film dispensing device 420 spool outputs 5 mm of film material. After which, at step 804, the dancer arm and treadle of the dynamic accumulator device 410 are adjusted to take up the slack in the film material. At step 806, the spool of the film dispensing device 420 outputs continues to output 25 mm of film material in 5 mm increments while adjusting the dancer arm and treadle of the dynamic accumulator device 410 to continue to take up the slack in the film material. Next, at step 808, the film dispensing device 420 outputs 5 mm film material while simultaneously performing an index motion for rotating body 110. The rotating body 110 will index at least 90 degrees. At step 810, the dancer arm and treadle of the dynamic accumulator device 410 are adjusted to let out slack to allow the rotating body 110 to index. Step 812 repeats the adjustments made in step 810 until this rotating body 110 has successfully indexed 90 degrees.

The previous examples have been provided merely for explanation and are in no way to be construed as limiting the present invention disclosed herein. While the invention has been described regarding various embodiments, it is understood that the words used herein are words of description and illustration rather than words of limitation. Further, although the invention has been described herein concerning particular means, materials, and embodiments, the invention is not intended to be limited to the particulars disclosed herein; instead, the invention extends to all functionally equivalent structures, methods, and uses, such as are within the scope of the appended claims. Those skilled in the art, having the benefit of the teachings of this specification, may affect numerous modifications thereto and changes may be made without departing from the scope and spirit of the invention in its aspects.

Any other undisclosed or incidental details of the construction or composition of the various elements of the disclosed embodiment of the present invention are not believed to be critical to the achievement of the advantages of the present invention, so long as the elements possess the attributes needed for them to perform as disclosed. The selection of these and other construction details are believed to be well within the ability of one of even rudimental skills in this area, in view of the present disclosure. Illustrative embodiments of the present invention have been described in considerable detail for the purpose of disclosing a practical, operative structure whereby the invention may be practiced advantageously.

The designs described herein are intended to be exemplary only. The novel characteristics of the invention may be incorporated in other structural forms without departing from the spirit and scope of the invention. The invention encompasses embodiments both comprising and consisting of the elements described with reference to the illustrative embodiments. Unless otherwise indicated, all ordinary words and terms used herein shall take their customary meaning. All technical terms shall take on their customary meaning as established by the appropriate technical discipline utilized by those normally skilled in that particular art area.

1. An apparatus for singulating separator material, comprising:
a rotating body having a flat face configured to receive a film material and rotate in an indexing or stepwise motion; and
a cutting device having an edge configured to cut the film material while it is adhered to the flat face of the rotating body during the indexing or stepwise motion.

2. The apparatus of claim 1, wherein the index motion comprises a complete stop of the rotating body and wherein the film material is cut during the complete stop.

3. The apparatus of claim 2, wherein the flat face is adapted to adhere to the film material using suction.

4. The apparatus of claim 3, further adapted to apply different amounts of suction to the flat face.

5. The apparatus of claim 1, further adapted to transfer the film material to a picking device after it has been cut.

6. The apparatus of claim 1, wherein the cutting edge comprises a blade.

7. The apparatus of claim 1, wherein the flat face of the rotating body further includes a feature adapted to receive the cutting edge.

8. The apparatus of claim 1, further comprising six flat faces.

9. The apparatus of claim 1, wherein compliance is achieved by spring means associated with each face.

10. The apparatus of claim 1, further comprising a base having means for deflecting the rotating body, wherein the rotating body is positioned on the base.

11. A system for separating and cutting a film, comprising:
a rotating body having at least two substantially flat faces, wherein the at least two substantially flat faces are configured for receiving a film material and rotate in an indexing or stepwise motion;
a cutting device having a cutting edge, wherein the cutting edge is configured to cut the film material while it is adhered to one of the at least two faces of the rotating body during the indexing or stepwise motion; and
a dynamic accumulation device for transferring the film material to the singulation device, wherein the dynamic accumulation device is configured to receive the film material at a constant rate and output it to the singulation device at a varying rate.

12. The system according to claim 11, further comprising a picking device, wherein the picking device is adapted to pick a piece of film from the singulation device after it has been cut by the cutting device.

13. A method for singulating separator material, comprising:
configuring a body having a flat face to receive a film material;
rotate the body in an indexing or stepwise motion; and
positioning a cutting device having an edge configured to cut the film material while it is adhered to the flat face of the body during the indexing or stepwise motion.

14. The method of claim 13, wherein the index motion comprises a complete stop of the rotating body and wherein the film material is cut during the stop.

15. The method of claim 14, wherein the flat face is adapted to adhere to the film material using suction.

16. The method of claim 15, further adapted to apply different amounts of suction to the flat face.

17. The method of claim 13, further adapted to transfer the film material to a picking device after it has been cut.

18. A method for separating and cutting a film, comprising:
configuring a body having at least two substantially flat faces for receiving a film material;
rotating the body in an indexing or stepwise motion;
positioning a cutting device having a cutting edge, wherein the cutting edge is configured to cut the film material while it is adhered to one of the at least two faces of the body during the indexing or stepwise motion.

19. The method of claim 18, comprising:
transfering the film material via a dynamic accumulation device to a singulation device, wherein the dynamic accumulation device is configured to receive the film material at a constant rate and output it to the singulation device at a varying rate.

20. The method of claim 19, further comprising a picking device, wherein the picking device is adapted to pick a piece of film from the singulation device after it has been cut by the cutting device.
